(19) United States
(12) Patent Application Publication
(10) Pub. No.: US 2010/0201813 A1
(43) Pub. Date: Aug. 12, 2010

(54) WHEEL-LESS MOBILE SECURITY SYSTEM DEPLOYMENT

(76) Inventor: MICHAEL G. MONSIVE, JR., Cypress, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/705,351

(22) Filed: Feb. 12, 2010

Related U.S. Application Data
(60) Provisional application No. 61/152,169, filed on Feb. 12, 2009.

(51) Int. Cl. H04N 7/18

(52) U.S. Cl. 348/143

(57) ABSTRACT

A mobile security apparatus without wheels is provided. The mobile security system may be suitable for transportation to and/or deployment in locations that are not accessible by roads, such as those covered by ice or snow, those in a body of water, etc. For some embodiments, the mobile security apparatus includes surveillance equipment, a pole for supporting the surveillance equipment, a base unit for supporting the pole, and wheel-less positioning means for transporting the mobile security system. Methods and apparatus for deploying the wheel-less mobile security systems are also provided.

### CROSS-REFERENCE TO RELATED APPLICATION

This application claims benefit of co-pending U.S. Provisional Patent Application Ser. No. 61/152,169 filed Feb. 12, 2009, which is incorporated herein by reference.

### BACKGROUND OF THE INVENTION

1. Field of the Invention

Embodiments of the present invention generally relate to security systems and, more particularly, to mobile security systems suitable for deployment in remote areas.

2. Description of the Related Art

Security systems have found applications in various areas. Homes, warehouses, retail stores, construction sites, banks, automated teller machines (ATMs), etc., all use security systems. Deployment of security systems may help detect and/or prevent intrusions, theft, vandalism, and other mishaps.

Security systems may be used to monitor remote installations, sites, etc., where vandalism or theft may be common. Such security systems may comprise surveillance equipment like cameras, video recorders, motion sensors, and infrared devices to collect information about disturbances at the remote installation or site.

Security systems may be made mobile by adding wheels to such systems. These mobile security systems may be transported to and easily repositioned at remote sites for monitoring purposes.

Conventional mobile security systems, however, may not be suitable for operation in a remote site or a location inaccessible by roads. Transportation and/or deployment of these security systems in such remote locations may be difficult for various reasons: the locations not being accessible by roads, the locations being in a body of water, etc.

Accordingly, what are needed are a security system that may be well-equipped for use in remote sites or other locations inaccessible by roads and may be suitable for transportation to and/or deployment in such sites, and techniques and apparatus for transporting and/or deploying the security system.

### SUMMARY OF THE INVENTION

One embodiment of the present invention provides an apparatus for surveillance. The apparatus generally includes surveillance equipment mounted on a pole, a base unit for supporting the pole, and wheel-less positioning means coupled to the base unit for transporting the apparatus.

Another embodiment of the present invention provides an apparatus for surveillance. The apparatus generally includes surveillance equipment mounted on a pole, a base unit for supporting the pole, and one or more legs coupled to the base unit for supporting at least a portion of the base unit above a surface.

Yet another embodiment of the present invention is a method. The method generally includes transporting one or more security systems to a first location to be surveyed and deploying at least one of the security systems at the first location.

Yet another embodiment of the present invention provides an apparatus. The apparatus generally includes means for transporting one or more security systems to a location to be surveyed and means for deploying at least one of the security systems at the location. Each of the security systems typically includes surveillance equipment mounted on a pole, a base unit for supporting the pole, and wheel-less positioning means coupled to the base unit for transporting each of the security systems.

### BRIEF DESCRIPTION OF THE DRAWINGS

A more particular description of the invention, briefly summarized above, may be had by reference to the embodiments thereof, which are illustrated in the appended drawings. It is to be noted, however, that the appended drawings illustrate only typical embodiments of the invention and are, therefore, not to be considered limiting in its scope, for the invention may admit to other equally effective embodiments.

FIG. 1 illustrates a security system in accordance with certain embodiments of the present disclosure.

FIG. 2 illustrates a mobile security system with a skid in accordance with certain embodiments of the present disclosure.

FIG. 3 illustrates a mobile security system with a sled in accordance with certain embodiments of the present disclosure.

FIG. 4 illustrates a mobile security system with a pair of skis in accordance with certain embodiments of the present disclosure.

FIG. 5 illustrates a mobile security system without wheels in accordance with certain embodiments of the present disclosure.

FIG. 6 illustrates a security system with legs in accordance with certain embodiments of the present disclosure.

FIG. 7 illustrates example operations for transporting and deploying one or more mobile wheel-less security systems in accordance with certain embodiments of the present disclosure.

FIGS. 8-10 illustrate example apparatus for transporting and/or deploying one or more wheel-less mobile security systems in accordance with certain embodiments of the present disclosure.

### DETAILED DESCRIPTION

Certain embodiments of the present disclosure provide a mobile security system without wheels. This wheel-less mobile security system may be suitable for transportation to and/or deployment in remote sites or other locations inaccessible by road, such as locations covered by ice or snow, those on a body of water, etc.

Certain embodiments of the present disclosure provide techniques and apparatus for deploying one or more wheel-less mobile security systems. These techniques and apparatus may facilitate deployment of the security systems in a time and/or cost efficient manner.

### An Example Security System

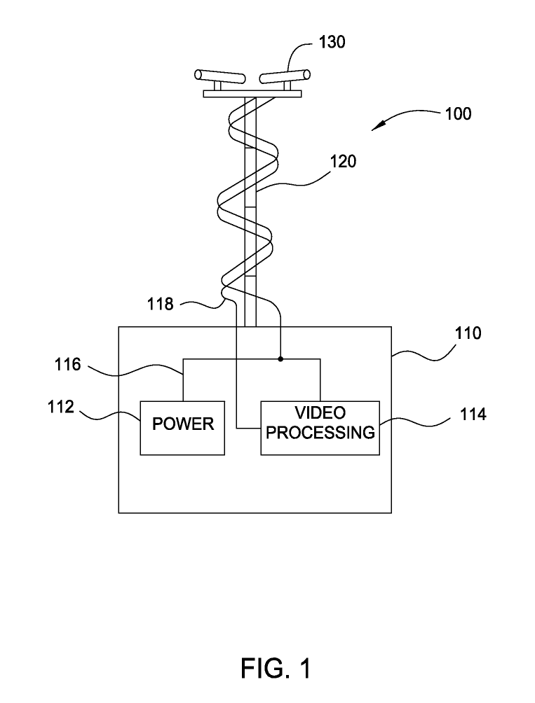

FIG. 1 shows a security system 100 according to some embodiments of the present disclosure. The security system may be transported to and deployed in remote locations. In such locations, the security system 100 may be used, for example, to detect the presence of trespassers at a site, record their criminal activities with photographs or video, sound an audible alarm, alert authorities and/or a monitoring service, or any combination thereof. As illustrated in FIG. 1, the security system 100 may comprise a base unit 110, a pole 120, and surveillance equipment 130.

The base unit 110 may enclose a power unit 112 and a processing unit, such as a video processing unit 114 illustrated in FIG. 1 and described in greater detail below. The power unit 112 may be configured to power the surveillance equipment 130 and the video processing unit 114.

The power unit 112 may comprise means for powering the surveillance equipment 130 and the rest of the security system 100. For example, for some embodiments, the power unit 112 may comprise means for receiving power from one or more external power sources (e.g., power from power lines of an electric grid, stepped down by a transformer). In other embodiments, the power unit 112 may comprise one or more batteries that may act as a stand-alone power source or may be used together with power from external power sources for powering the surveillance equipment 130 and the rest of the security system 100. The power unit 112 may provide power to the surveillance equipment 130 and the rest of the security system 100 including the video processing unit 114 via one or more power cables 116.

In certain embodiments, the power unit 112 may comprise a chargeable power source, a charging power source, and one or more components for controlling charging of the chargeable power source. The chargeable power source may be configured to power the surveillance equipment 130 and the video processing unit 114. The chargeable power source may be any of various suitable devices capable of being repeatedly recharged and supplying sufficient power. For some embodiments, the chargeable power source may comprise one or more rechargeable batteries. Any of various types of rechargeable batteries may be used. For example, the chargeable power source may comprise one or more gel batteries (also known as gel cells), which contain battery acid in a gel form. For other embodiments, the chargeable power source may comprise other types of lead-acid batteries, such as one or more absorbent glass mat (AGM) lead-acid batteries. The terminals of the chargeable power source may be connected with the surveillance equipment 130 and the video processing unit 114 via the power cable 116 in an effort to provide power to the components of the system 100.

The charging power source may provide means to charge the chargeable power source. The charging power source may comprise any of various suitable power sources, such as generators that may convert mechanical energy into electrical energy, solar cells that may convert solar energy into electrical energy, etc., used alone or in combination. For some embodiments, the charging power source may comprise an engine driving an alternator to charge the chargeable power source, similar to the engine/alternator/battery combination in a modern automobile. For other embodiments, the charging power source may comprise an engine-generator set (gen-set), which is the combination of an engine driving an electrical generator. The engine of the gen-set may comprise a diesel engine or an internal combustion engine (ICE) using any suitable fuel source, such as gasoline. The engine may comprise a single-cylinder or multiple cylinders and may be liquid-cooled or air-cooled. In addition to the engine and alternator, such a charging power source may include a fuel tank, an engine speed regulator, an alternator voltage regulator, cooling and exhaust systems, and a lubrication system.

For other embodiments, the charging power source may comprise an engine-generator set (gen-set), which is the combination of an engine driving an electrical generator. Sometimes, the combination is simply referred to as a generator, taking the engine for granted. In addition to the engine and generator, the gen-set may include a fuel tank, an engine speed regulator, a generator voltage regulator, cooling and exhaust systems, and a lubrication system. As described above, the engine of the gen-set may comprise a diesel engine or an internal combustion engine (ICE) using any suitable fuel source, such as gasoline. The engine may comprise a single-cylinder or multiple cylinders and may be liquid-cooled or air-cooled. In the embodiments of charging power sources having an engine described above, the chargeable power source or a separate source (e.g., a battery) may provide power to a starter motor for powering on the engine.

For still other embodiments, the charging power source may comprise a gas engine generator (GEG) where the mechanical energy powering the electrical generator is heat energy from the burning of a gas. For example, the gas burned in a GEG may be natural gas or propane (liquid or gas).

As the efficiency of solar cells continues to improve, the charging power source may comprise one or more solar panels for some embodiments. Each solar panel may comprise several solar cells and may be mounted on an upper or angled lateral surface of the base unit 110.

For some embodiments, the security system 100 may be configured to draw power from an external power source (not shown) whenever such a source is available. The external power source may comprise, for example, AC voltage (e.g., 110 V_{AC} or 220 V_{AC}) from an electric power grid. In such cases, the base unit 110 may include one or more electrical power outlets (also called receptacles or sockets) for receiving an AC power plug from an extension cord, for example. The type of electrical outlet(s) may be dependent on the type of electrical AC connector used in the country where the security system 100 is to be deployed. In other cases, the external power source may comprise an external battery.

While an external power source is provided, such security systems may draw power from this external source, perhaps charging or maintaining the chargeable power source for some embodiments. In this manner, the external power source may function as a battery tender. Once the external power source is removed, the security system 100 may be powered from the chargeable power source as described above, at least until the charging power source is signaled to generate power by the control unit.

The video processing unit 114 may perform different video processing functions, such as video recording, image processing, time stamping, and video encoding. For example, the video processing unit may comprise a digital video recorder (DVR) or a videocassette recorder (VCR). Video and other signals from the surveillance equipment 130 may be input to the video processing unit 114 via one or more signal cables 118. Furthermore, the video processing unit 114 may control operation of the surveillance equipment 130 via the signal cables 118. For example, such control operations may include panning, tilting, or zooming operations of one or more cameras composing the surveillance equipment 130. For some embodiments, one or more control signal cables separate from the signal cables 118 may be used by the video processing unit 114 for sending control signals to the surveillance equipment 130.

Certain embodiments of the present disclosure may provide means for supporting the surveillance equipment 130 at a desired height above the base unit 110 in an effort to offer a clear view of a large surveillance area. For example, a mast or a pole 120 may support the surveillance equipment 130 when mounted on the base unit. The pole 120 may be removable from or statically mounted on the base unit 110. For some embodiments, the pole 120 may have a fixed length. For other embodiments, the pole may be a telescoping structure that may allow the height of the surveillance equipment 130 to be adjusted. For example, a galvanized three-section telescoping pole with adjustable height (e.g., from 6 feet to 25 feet, or 1.83 m to 7.62 m) may be used. The means for telescoping the pole 120 may include electric winches, air cables, manual winches, a twist lock, etc. For example, the height of the pole may be adjusted using a dual winch system. For some embodiments, the pole 120 may comprise an eyelet for raising the pole 120.

Some embodiments may comprise means for raising, lowering, or otherwise positioning the pole 120. For example, a hinge mechanism may be provided to allow the pole 120 to rotate between an approximately upright position for surveillance and a fully or at least a more prone position for transportation. For other embodiments, the pole 120 may not be hinged. For such embodiments, the pole 120 may be stepped in a block or other fixture on the base unit 110 in an effort to conduct surveillance. When the surveillance equipment is not in use, the pole 120 may be dismounted (i.e., removed from the block or other such fixture) and lowered in an effort to facilitate transportation and/or deployment.

The surveillance equipment 130 may comprise means for collecting information about the site in which the security system 100 is deployed. For some embodiments, the surveillance equipment 130 may comprise one or more surveillance devices such as cameras. A variety of cameras may be used. For example, some embodiments may use pan/tilt/zoom (PTZ) cameras or fixed cameras with built-in infrared (IR) for nighttime imaging. The collected information may be optionally processed onsite by the video processing unit 114. For some embodiments, the surveillance equipment 130 may comprise any of various devices for detecting sound and/or motion such as audio recorders, motion sensors employing, e.g., lasers, or infrared sensors. Some embodiments may use surveillance equipment suitable for use in harsh environments involving high humidity and/or extreme temperatures.

The system 100 may include one or more alarms and means for activating the alarms. For example, a motion detector may be coupled with an audible or silent alarm to trigger the alarm when suspicious activity is detected. For some embodiments, the system 100 may comprise means for activating a remote siren that may be mounted away from the rest of the security system. For some embodiments, the alarm may include a light that turns on in an effort to deter trespassers and/or assist the camera(s) with imaging. Certain embodiments may include integrated global positioning system (GPS) tracking for increased functionality and security.

For some embodiments, the security system 100 may comprise means for transmitting the collected and/or processed information to a different location to facilitate remote monitoring. For example, the security system may include high speed cellular, General Packet Radio Service (GPRS), Enhanced Data rates for Global Evolution (EDGE), satellite, Wi-Fi, WiMAX (Worldwide Interoperability for Microwave Access), mesh, and/or local area network (LAN) capabilities to transmit the information to a remote location for monitoring, primary processing or further processing. In other embodiments, in addition to transmitting the collected/processed information, the security system 100 may be configured for receiving collected/processed information from one or more security systems similar in structure and function to the security system 100, using communication capabilities similar to the ones described above.

For some embodiments, the security system may send an e-mail, text message (Short Message Service, or SMS), or a paging notification to a remote site, personal computer (PC), server, or mobile device whenever an alarm has been triggered in an effort to alert someone. This message may include a video or a camera snapshot of the monitored site starting from when the alarm was triggered or shortly thereafter. For some embodiments, the triggering of an alarm may provoke the security system to send such a message, notification, or other information via file transfer protocol (FTP).

### Example Wheel-Less Mobile Security Systems

Embodiments of the present disclosure provide apparatus for facilitating wheel-less transportation and/or deployment of a security system such as the security system 100. These apparatus may allow the security system 100 to be transported to areas that may normally be inaccessible by road, such as areas covered by ice, snow, or water.

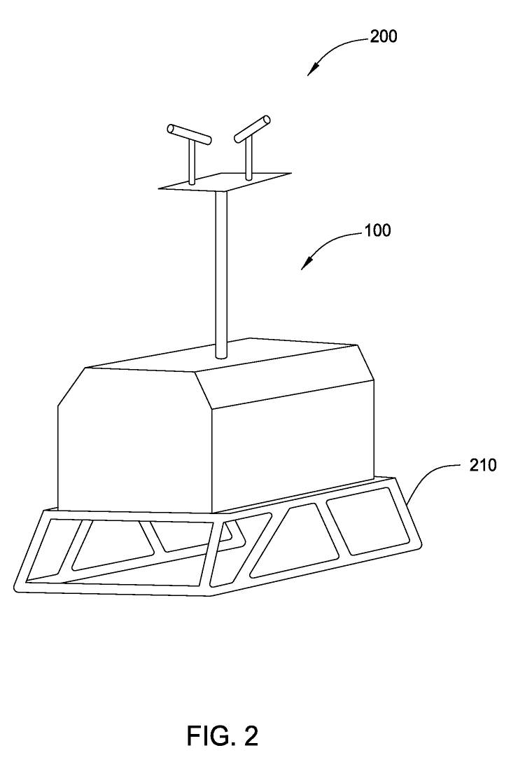

FIG. 2 illustrates an assembly 200 comprising the security system 100 and a skid 210. Any of various types of skids (e.g., skids made of plastic, metal, wood or any other suitable material) may be used in the assembly 200. For some embodiments, the skid 210 may be smooth enough to be slideable on a flat surface. For other embodiments, the skid 210 may have two or more rails to slide across ice or snow, for example.

To achieve such an assembly 200, the security system 100 and the skid 210 may be coupled together using any of various suitable mechanisms, such as hardware (e.g., brackets and machine screws or bolts), welding, an adhesive, a polymer, hook-and-loop fasteners (e.g., Velcro), etc. For some embodiments, the security system 100 may be simply placed above the skid 210 such that friction and gravity alone may be used to secure the security system 100 to the skid 210. In other embodiments, a fence comprising one or more rails, slats, or other raised edges from the skid 210 may be used in such a way that the fence secures the security system 100 in place. For other embodiments, the security system 100 may be strapped to the skid 210 with any suitable means, such as tie downs, straps, rope, line, or bungee cords. Any of these coupling means may help the assembly 200 to stay intact during transportation.

The assembly 200 may include means for being driven (i.e., pushed, pulled, or towed) by a suitable external force from a vehicle (e.g., a truck, snowmobile, tank, or bulldozer) or one or more animals (e.g., horses, mules, oxen, reindeer, llamas, dogs, etc.) in order to facilitate transportation of the assembly. The assembly 200 may also include means for facilitating hauling of the assembly by a motor vehicle such as a tow ring, a cleat, etc.

The assembly 200 may further include means for facilitating transportation of the assembly using other techniques. For example, for some embodiments, the underside of the skid 210 may include means for receiving the tines of a lifting device such as a forklift. Some embodiments may include means that may allow transportation (sliding) of the assembly 200 up or down a slope. For example, the assembly 200 may include means for connecting with a winch that may control the movement of the assembly 200 up or down the slope.

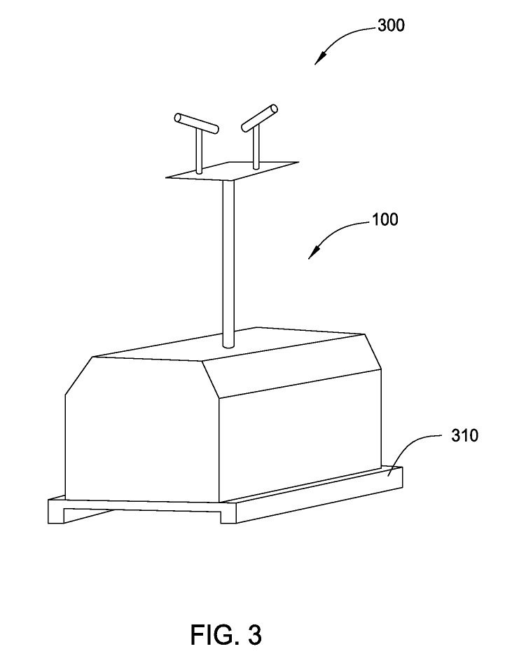

Some embodiments may provide means that may facilitate transportation of the security system 100 to locations that may be inaccessible by road due to a lack of roads, the existing roads being unusable due to inclement weather conditions, or other reasons. For example, some embodiments may include a sled that may allow transportation of the security system 100 in such conditions. FIG. 3 illustrates an assembly 300 comprising the security system 100 and a sled 310. Proper selection of the sled 310 may facilitate transportation of the assembly 300 on snow, ice, or even sand. The security system 100 and the sled 310 may be coupled together using any of various suitable techniques such as those described above. These techniques may ensure that the assembly 300 remains intact during transportation as described above. The assembly 300 may include means that may allow the assembly to be transported and repositioned by animals or vehicles as described above.

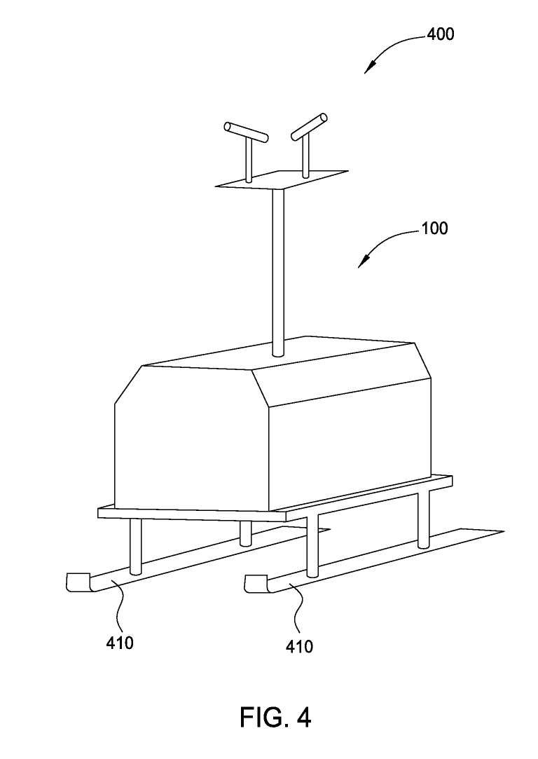

Other embodiments may include an assembly comprising one or more skis to facilitate transportation of the security system 100. FIG. 4 illustrates an assembly 400 comprising the security system 100 and a ski arrangement 410 coupled together using any of various suitable techniques such as those described above. The coupling may ensure proper transportation of the assembly 400. The assembly 400 may be moved by means similar to the means described in connection with the assembly 300 in FIG. 3.

Employing one or more skis may have certain advantages. For example, due to the skis having less surface area than a typical sled, less friction may be involved, and hence, the assembly 400 with skis may be easier to push or pull than assemblies with a skid or a sled. Using an arrangement with wide skis, however, may aid transportation of the security system 100 in deep and/or fluffy snow conditions.

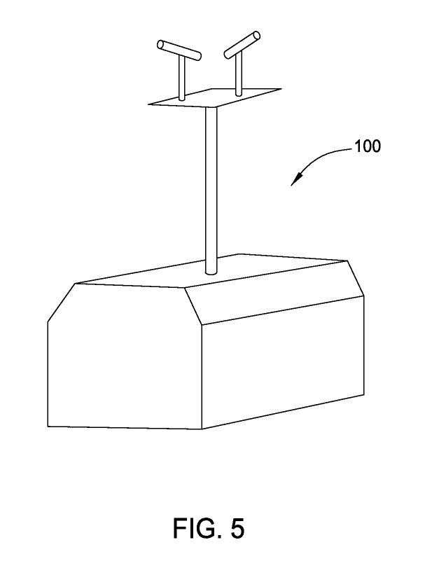

Transportation and/or deployment means comprising sleds, skis, etc., may not be available at all times. Some embodiments of the present disclosure may overcome this limitation by minimizing dependence on external means for transportation and/or deployment. For example, for some embodiments, the underside of the security system 100 may be made smooth to facilitate hauling or pushing of the security system on a surface with low friction such as ice. In other words, the security system 100 without wheels may be simply dragged or pushed across ice, snow, or sand, for example, without the addition of any skid, sled, skis, etc. Such a security system 100 is shown in FIG. 5. Such embodiments may also have the advantage of lower cost than the assemblies of FIGS. 2-4. The security system 100 may comprise means that may facilitate connection with an external body capable of hauling the security system 100 as described above. In certain embodiments, the security system 100 in FIG. 5 may further comprise means for allowing connection with arrangements such as skids, sleds, skis, legs, etc., in order to facilitate transportation/deployment of the security system using such arrangements if available.

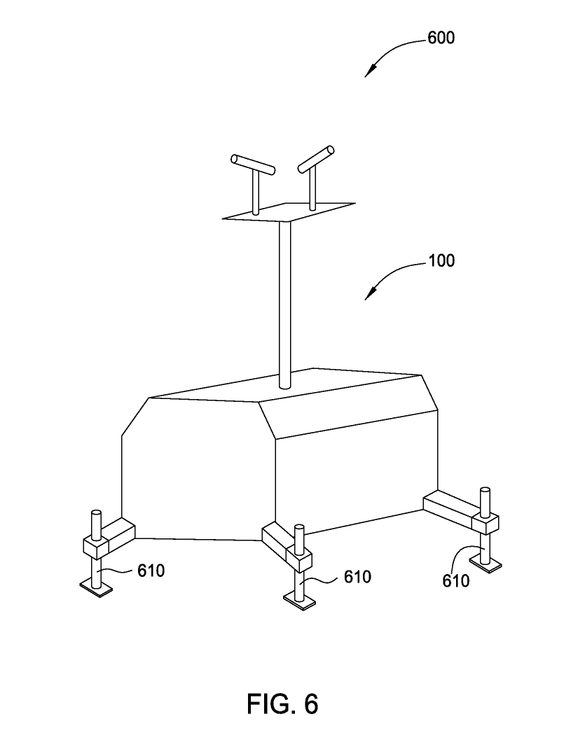

Some embodiments may provide means for supporting the security system 100 above a surface (e.g., up off the ground) and/or for stabilizing the security system 100. For example, FIG. 6 illustrates an assembly 600 comprising the security system 100 and legs 610. The legs 610 may comprise outriggers or other types of stabilizers, for example. Outriggers may stabilize the entire structure of the security system 100 in wind gusts up to about 65 mph (104.6 kilometers per hour) and prevent the system from being blown down or knocked over.

The security system 100 and the legs 610 may be coupled together using any of various suitable techniques such as welding or bolting together with hardware (e.g., brackets, bolts, machine screws, etc.).

The height of the legs 610 may be individually or jointly adjustable in an effort to make the security system 100 suitable for deployment in large areas. Height adjustability of the legs may further facilitate deployment of the security system on slopes and uneven surfaces. For example, tipping of the security system 100, when placed on a slope, may be avoided by adjusting individual heights of the legs 610 and therefore maintaining the security system 100 at a suitable angle with respect to the surface of the slope in an effort to prevent tipping. In other words, the security system 100 may be leveled by individually adjusting the height of the legs 610. Proper selection of the legs 610 may even prevent skidding of the assembly 600 when placed on a slope.

Other embodiments may include means for facilitating transportation and/or deployment of the security system 100 on water. For example, floating structures such as pontoons, plastics such as Styrofoam, etc., may be used to keep the security system 100 afloat or mobile in water. This may facilitate monitoring of remote sites on or surrounded by water, the monitoring of which may be desirable or only possible from the surrounding water (e.g., docks or boats under construction, flooded regions, etc.). Such embodiments may further comprise one or more outriggers in an effort to stabilize the floating security system on rougher water.

### Deployment of Wheel-Less Mobile Security Systems

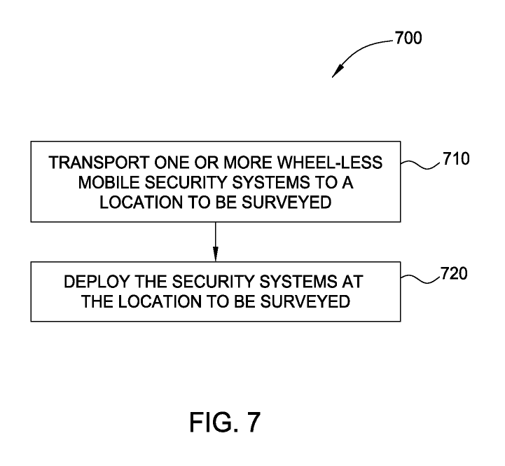

FIG. 7 illustrates example operations 700 for transporting and/or deploying one or more wheel-less mobile security systems 100 in accordance with certain embodiments of the present disclosure. The operations 700 may begin at 710 with the transportation of one or more wheel-less mobile security systems 100 to a location, such as a site or installation to be surveyed. The systems 100 may, for example, be transported from the factory or another installation or site that was previously surveyed using the systems 100. Certain embodiments may involve transporting the security systems 100 via roads using means such as motor vehicles (e.g., trucks), by air using means such as airplanes or helicopters, by rail using means such as trains, over water using means such as boats, etc. If the location is not accessible by road or if the existing roads are not usable, the security systems 100 may be transported to the location using any of various suitable means such as motor vehicles and animals as described above.

At 720, the security systems 100 may be deployed at the location. In addition to the deployment techniques described above, techniques such as those described below may be used to deploy the security systems 100. The following techniques may have certain advantages and may make deployment of the security systems 100 easier. For example, certain deployment techniques may reduce overhead costs by making use of existing features of the systems 100. Some techniques may include features that may help deploy the systems 100 in a time efficient manner.

In certain embodiments of the present disclosure, deployment of the security system 100 may be achieved utilizing the system's mobility features. Techniques used for deploying the security system 100 may take advantage of these features. For example, if the security system 100 includes a smooth underside (as does the security system illustrated in FIG. 5), deployment of the system 100 may be achieved via sliding of the system 100 as part of the deployment procedure. For other embodiments, deploying the wheel-less mobile security system 100 may comprise using a forklift to remove the security system 100 from any suitable transportation device used at 710, such as from the flatbed of a truck or other vehicle.

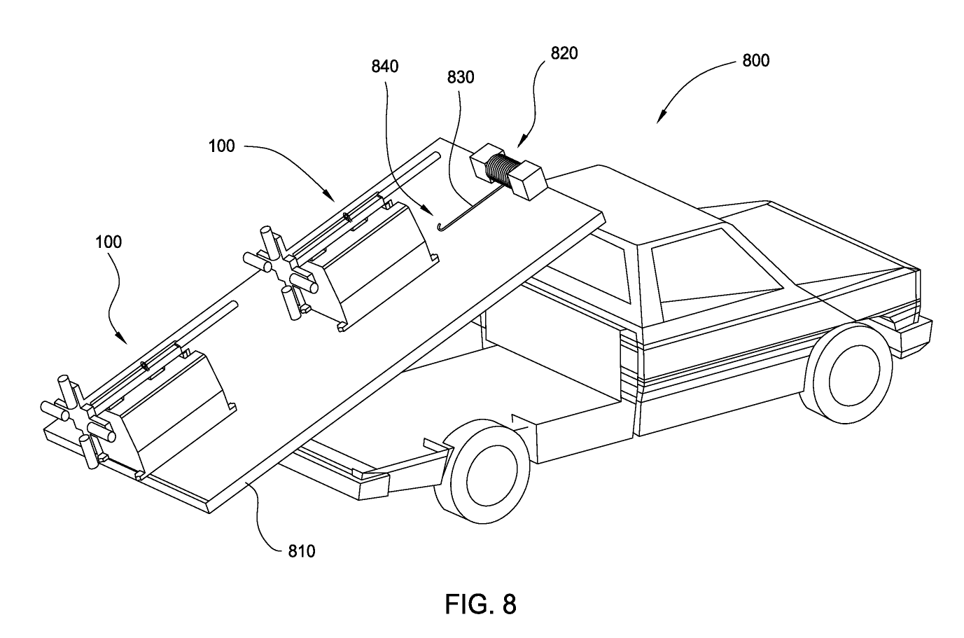

Another example deployment technique may involve a tilt-bed style truck 800 as shown in FIG. 8. In addition to facilitating deployment of the system 100 at a site to be monitored at 720, the truck 800 may be used to transport the system 100 to the site at 710. Deployment of the security system 100 at the site may be achieved by raising (i.e., tilting) the tilt-bed 810 and allowing the system 100 to slide down the tilt-bed 810, onto the ground or any other suitable surface, in an effort to unload the system 100 from the truck 800.

Sliding of the system 100 may be controlled by any of various suitable mechanisms, such as a winch 820, as illustrated in FIG. 8. The winch 820 may be connected with the security system 100 via an eyelet such as the eyelet described above in connection with the pole 120 in FIG. 1. For some embodiments of the security system 100, the eyelet may be situated in a different part of the system 100 (e.g., on the base unit 110 shown in FIG. 1). Connection between the winch 820 and the eyelet may be achieved by using suitable means such as a chain or a cable 830 coupled to a hook 840 as shown in FIG. 8.

For some embodiments of the present disclosure, means for unloading the system 100 from the truck 800 may include devices such as a pulley or one or more ramps that are capable of acting as an extension of the truck bed 810. These means may facilitate unloading (and loading) of the system 100 onto a surface that is higher or lower than the truck bed 810.

Redeployment of the security system 100 at a new location on the site may be achieved by loading the security system 100 back on the truck 800, transporting the system 100 to the new location, and unloading the system 100 from the truck 800 as described above. The system 100 may be loaded back on the truck 800 by first lifting the system 100 off the ground or any other suitable surface manually or, if desired, using suitable mechanisms such as a pulley, a hoist, a ramp, etc. The system 100 may then be placed on the truck bed 810. Following this, the system 100 may be positioned on the truck 800 by sliding the system 100 up the truck bed 810 using the winch 820. For some embodiments, the truck 800 may include more than one winch to make loading or unloading of the security systems 100 easier and/or faster. The security system 100 may be secured to the truck 800 using various suitable mechanisms comprising tie-downs (e.g., straps, belts, chains, etc.) or hardware (e.g., brackets, machine screws or bolts, etc.).

For some embodiments of the present disclosure, a separate tilt-bed style trailer that is not part of, but capable of being hitched or otherwise coupled to a truck or any other hauling/pushing device may be used for transporting and deploying the system 100. Deployment of the system 100 using the trailer may be achieved as described above in connection with the truck 800. The truck or trailer used for deployment may be configured to carry a plurality of security systems 100 (e.g., up to about four). Techniques such as those described above may also be used for deploying security systems 100 comprising skids, sleds, etc., since these security systems may be capable of sliding on a surface as well.

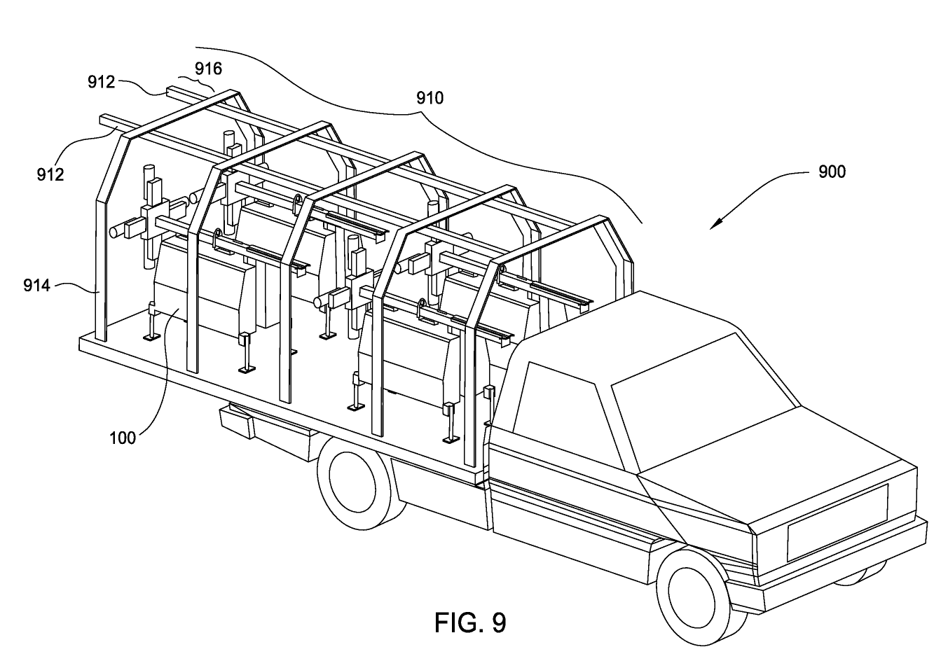

Some deployment techniques may make use of one or more constructional and/or deployment/positioning features (e.g., an eyelet) of the security system 100. For example, FIG. 9 illustrates a truck 900 with an overhead rail assembly 910 for deploying one or more (e.g., up to about four) security systems 100. The rail assembly may comprise one or more rails 912 supported by two or more frames 914 as shown in FIG. 9. The rail assembly 910 may further comprise mechanisms such as winches, pulleys, cables, etc. These mechanisms may be employed in an effort to move the systems 100 with respect to the rail assembly 910 when deploying the systems 100. For example, if winches are used, the winches may be configured to lift the security systems 100 off the truck bed, carry the systems 100 beyond the rear end of the truck 900, and lower the systems 100 onto the ground or any other suitable surface at a selected location. A portion 916 of the rails 912 may extend beyond the rear end of the truck 900 in order to facilitate lowering the systems 100.

According to some deployment techniques, the systems 100 may simply be hauled to the rear end of the truck 900 and then placed on a suitable surface. For some embodiments, means for unloading the systems 100 from the truck 900 may include devices, such as a ramp as described above. Redeployment of the systems 100 at a new location may be achieved by loading the systems 100 back on the truck 900 and unloading the systems 100 at the new location using suitable mechanisms as described above.

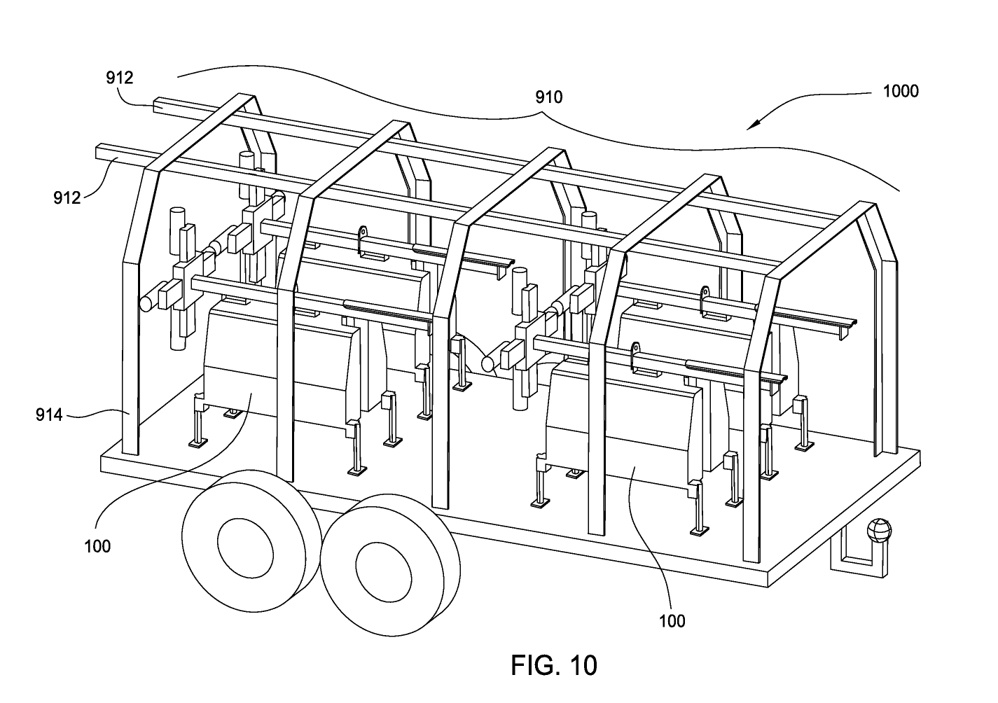

For some embodiments of the present disclosure, the overhead rail assembly 910 may be part of a trailer, rather than a truck. Such a trailer 1000 is illustrated in FIG. 10. The trailer 1000 may be used for deploying one or more (e.g., up to about four) security systems 100. Transportation of the trailer 1000 along with the security systems 100 placed on the trailer 1000 may be achieved by using suitable means such as a motor vehicle (e.g., a truck) to which the trailer 1000 may be hitched or otherwise coupled. Deployment of the security systems 100 from the trailer 1000 may be similar to the deployment techniques described above with respect to the truck 900.

Furthermore, the trailer 1000 may be hitched to the truck 900. In this manner, more security systems 100 can be transported than by either the trailer 1000 or the truck 900 by themselves. For example, if the truck 900 can transport four security systems 100 and the trailer 1000 can transport an additional four security systems 100, then up to eight systems 100 may be deployed at a single site (having one or more deployment locations), or any combination of up to eight systems may be deployed at up to eight different sites.

The apparatus illustrated in any of FIGS. 8-10 may provide techniques for deploying a plurality of security systems 100 in a cost efficient manner. For example, to deploy a plurality (e.g., up to about 4) of security systems 100 at different locations on a site, instead of using as many deployment devices (e.g., trucks), a single deployment device (e.g., a truck 800 as shown in FIG. 8) may be used. The deployment device may be capable of carrying the systems 100 to a particular location on the site, deploying one of the systems 100 at the location, moving to a different location on the site, deploying another system 100 at the new location and so on. If the security system 100 comprises wheels, a plurality (e.g., up to about 2) of the security systems 100 may be deployed in a similar manner. In other words, more security systems 100 may be carried on one truck 800, or fewer trucks 800 may be used to carry the same number of systems 100 to the site.

While the foregoing is directed to embodiments of the present invention, other and further embodiments of the invention may be devised without departing from the basic scope thereof, and the scope thereof is determined by the claims that follow.

1. A method comprising:
transporting one or more security systems to a first location to be surveyed, wherein each of the security systems comprises:
surveillance equipment mounted on a pole;
a base unit for supporting the pole; and
wheel-less positioning means coupled to the base unit for transporting each of the security systems; and
deploying at least one of the security systems at the first location.

2. The method of claim 1, wherein the wheel-less positioning means comprises a skid.

3. The method of claim 1, wherein the wheel-less positioning means comprises a sled.

4. The method of claim 1, wherein the wheel-less positioning means comprises one or more skis.

5. The method of claim 1, wherein the wheel-less positioning means comprises a floatation device.

6. The method of claim 5, wherein the floatation device comprises one or more pontoons.

7. The method of claim 1, wherein the wheel-less positioning means comprises one or more legs coupled to the base unit for supporting at least a portion of the base unit above a surface.

8. The method of claim 1, wherein transporting the security systems comprises using a truck or a trailer with an overhead rail assembly for deploying the at least one of the security systems.

9. The method of claim 8, wherein deploying the at least one of the security systems comprises:
lifting the at least one of the security systems off a bed of the truck or the trailer using the overhead rail assembly;
moving the at least one of the security systems via the overhead rail assembly beyond a rear end of the truck or the trailer; and
lowering the at least one of the security systems at the first location to be surveyed using the overhead rail assembly.

10. The method of claim 8, wherein the overhead rail assembly comprises at least one of a winch, a pulley, and a cable for deploying the at least one of the security systems.

11. The method of claim 1, wherein transporting the security systems comprises using a truck or a trailer, the truck or the trailer having a tilt-bed.

12. The method of claim 11, wherein deploying the at least one of the security systems comprises:
raising the tilt-bed of the truck or the trailer; and
sliding the at least one of the security systems down the raised tilt-bed onto a surface of the first location to be surveyed.

13. The method of claim 12, wherein sliding the at least one of the security systems down the tilt-bed comprises controlling the sliding of the at least one of the security systems via a winch, wherein the winch is coupled to an eyelet of the at least one of the security systems by a hook.

14. The method of claim 12, wherein deploying the at least one of the security systems further comprises using a ramp, wherein the ramp facilitates deploying the at least one of the security systems onto the surface.

15. The method of claim 1, further comprising:
transporting the at least one of the security systems from the first location to be surveyed to a second location to be surveyed; and
deploying the at least one of the security systems at the second location.

16. An apparatus comprising:
means for transporting one or more security systems to a location to be surveyed, wherein each of the security systems comprises:
surveillance equipment mounted on a pole;
a base unit for supporting the pole; and
wheel-less positioning means coupled to the base unit for transporting each of the security systems; and
means for deploying at least one of the security systems at the location.

17. The apparatus of claim 16, wherein the wheel-less positioning means comprises at least one of a skid or one or more skis.

18. The apparatus of claim 16, wherein the means for transporting comprises a truck or a trailer capable of transporting four or more security systems.

19. The apparatus of claim 16, wherein the means for deploying comprises a tilt-bed of a truck or a trailer, the tilt-bed having a winch for controlling sliding of the at least one of the security systems on the tilt-bed during deployment.

20. The apparatus of claim 16, wherein the means for deploying comprises an overhead rail assembly having at least one rail and capable of lifting the at least one security system and moving the at least one security system with respect to the rail.
